(19) United States
(12) Patent Application Publication
(10) Pub. No.: US 2026/0085193 A1
(43) Pub. Date: Mar. 26, 2026

(54) METHODS OF MODIFYING THE SURFACE OF RECOVERED CARBON BLACK WITH FENTON SOLUTIONS

(71) Applicant: WASTEFRONT AS, Oslo (NO)

(72) Inventors: Jorge Moreno Trejo, Olso (NO); Henrik Selstam, Mölnlycke (SE); John Williams Hemmings, Fripp Island, SC (US)

(73) Assignee: WASTEFRONT AS, Oslo (NO)

(21) Appl. No.: 19/111,340

(22) PCT Filed: Aug. 25, 2023
(86) PCT No.: PCT/US2023/031161

§ 371 Date: Mar. 13, 2025

Related U.S. Application Data
(60) Provisional application No. 63/407,357, filed on Sep. 16, 2022.

(51) Int. Cl. C09C 1/56; C08K 3/04; C09C 1/58

(52) U.S. Cl. CPC C09C 1/565; C08K 3/04; C09C 1/58; C01P 2004/50

(57) ABSTRACT

Methods treat recovered carbon black by oxidizing the surface of the material using a Fenton solution. The Fenton solution may be included in a liquid binder composition used during pelletization of recovered carbon black. The use of a Fenton solution treatment advantageously reduces the surface contamination of the recovered carbon black and maintains a sufficiently low pH.

### TECHNICAL FIELD

The disclosure relates to methods of treating recovered carbon black by oxidizing the surface of the material using a Fenton solution and is applicable to both reinforcing and pigment applications of recovered carbon black. The recovered carbon black can be in the form of pellets, powders or aqueous slurries.

### BACKGROUND

Recovered carbon black (rCB) is prepared from end of life tyres (ELTs) and other reinforced rubber goods by recycling chemical processes in particular pyrolysis, which heats the ELTs in the absence of air forming a vapor and residual solids. The vapor is typically cooled to recover pyrolysis oil leaving a fuel gas in the vapor phase. The residual solid, is often called “Raw Recovered Carbon Black”, but is sometime referred to as char. The Raw Recovered Carbon Black is converted to Recovered carbon black by milling to a uniform particle size or fine size (typically 1-10 microns), often followed by pelletizing for more convenient transport, handling and storage. Recovered carbon black is made up of the various grades of carbon black which were originally in the source material (e.g., waste tyres) together with inorganic contaminants, residual volatile materials and new amorphous carbon produced by depolymerization and cracking of the rubber component.

Recovered carbon black is a relatively new material in commerce and, consequently, methods for analysis and applications are not as well established as for virgin carbon blacks (vCB). However, based on common terminology and recommended analytical and applications tests (such as ASTM D8178-19, “Standard Terminology Relating to Recovered Carbon Black (rCB)”), the general finding is that rCB is typically less reinforcing than vCB with the equivalent OAN and BET values.

Due to the lower reinforcing properties of rCB, it is currently considered mainly for use in semi-reinforcing applications or as a partial substitution for vCB. Specifically, rCB material is typically used as a partial substitute for ASTM N600 or N500 series Carbon Blacks in applications such as side wall formulations for automotive tyres.

The performance deficit in rCB compared to vCB is, in part, due to the presence of heavy hydrocarbons (measured by using the amount of volatile carbonaceous matter (VCM) as an index) partially blocking sites through which rubber would otherwise be able to interact with the carbon and partly due to the nature of the chemical groups on the surface being less compatible with the rubber compound. As rCB is prepared by pyrolysis, there is usually a correlation between the amount of residual hydrocarbons (measured by VCM) and the chemical nature of the surface (measured by ASTM D-1512 pH). With conventional pyrolysis processes, it is possible to reduce the VCM content, but this typically has the effect of simultaneously reducing surface oxygenated sites and elevating the pH, which makes the surface less compatible with rubber compounds.

The interaction of rCB with rubbers in compounds also depends on the surface properties of the carbon particles in the rCB as well as how they are assembled into larger structures. A characteristic of carbon black surfaces in general is that there are a significant number of surface oxygenates, for example, phenol groups as well as ketones and carboxylic acids. Those surface oxygen groups affect the pH of the surface (as measured in ASTM D1512) and also affect the polarity of the surface which in turn affects the interaction between the rubber molecules and the carbon black particles. That effect can be quantified to some extent using Hansen Solubility Theory¹.

Another measurement of rCB that is important is the Transmittance of Toluene Extracts (ASTM D1618), which is a measure of loosely bound “oil” attached to the carbon surface. Such loosely bound “oil” is readily dissolved into toluene and discolours the toluene. This is a convenient measure of “cleanliness” of the rCB.

In certain applications (rubber goods in food contact), the PAH levels are important because rCB can offer low levels of polycyclic aromatic hydrocarbons (PAH). PAH compounds are formed during the incomplete combustion of coal, oil, and gas and are heavily regulated in air, water, and soil due to their links to cancer and cardiovascular disease. It is expected that in the future low PAH will be an advantage also for tyre applications. This is because tyres are abraded by use and a large fraction of the rubber and carbon black is thereby released to the environment.

Various methods have been proposed for post treating rCB to improve the physical properties to be more comparable to vCB. Certain existing treatments are typically designed to remove contamination (VCM or “oil”) or oxidize the surface to enhance dispersibility in polar materials. Other existing treatments make use of solvents to remove inorganic contaminants from the rCB. None of the existing methods or proposed methods are entirely satisfactory since they are either extremely expensive, ineffective in improving reinforcing properties or both. Therefore, there remains a need for more efficient methods for treating rCB which can efficiently remove volatile matter as well as oxidize the surface of the rCB.

### SUMMARY

We provide methods of producing carbon black pellets comprising feeding an amount of unpelletized recovered carbon black as a feed amount into a pellet mill, dispersing a binder composition into said pellet mill, and pelletizing the recovered carbon black, wherein the binder composition comprises a Fenton solution.

We also provide a carbon black pellet comprising recovered carbon black and a binder composition, wherein the binder composition comprises a Fenton solution.

We further provide a carbon black slurry comprising recovered carbon black dispersed in a liquid medium, wherein the liquid medium comprises a Fenton solution.

### BRIEF DESCRIPTION OF THE DRAWINGS

FIG. 1 is a schematic of a conventional wet pellet formation system.

FIG. 2 is a graph showing the cumulative distribution crush strength of Example 1 and Comparative Examples 1 to 3.

### DETAILED DESCRIPTION

We provide methods of treating recovered carbon black using a Fenton solution. We discovered that rCB pellets prepared with the use of Fenton solution have better dispersion characteristics as well as superior in rubber performance compared to pellets prepared using water as a binder, without being bound by theory, we believe that the superior performance is by virtue of the low pH of the carbon surface relative to rCB pellets prepared by conventional techniques.

A Fenton-type aqueous oxidizing solution is used to modify the surface of recovered carbon black by reducing adsorbed hydrocarbons and adding oxygen containing groups such as phenols and carboxylic acids to the surface structure of the carbon itself. The treatment improves the wettability of the recovered carbon black and modifies the interaction between the recovered carbon black and certain rubber compounds.

In the context of treatment of recovered carbon black, Fenton chemistry is believed to:
Convert some of the surface carbon (in benzene rings) into phenol groups,
Remove some “oil” by oxidizing,
Remove some amorphous carbon,
Enable economic viability of the process as it is low cost, and
Lower environmental impact, ensuring a clean overall production.

Other free radical catalyzed reactions are also possible. For example, to the extent that molecules with free olefin groups are present, the usual free radical chain reactions are possible (such as chain growth at suitable sites, conversion of olefins to diolefins).

A “Fenton solution” is an aqueous solution comprising in addition to water a transition metal salt, an acid and hydrogen peroxide. The solution rapidly oxidizes residual hydrocarbons as well as the surface of carbon. Fenton chemistry makes use of hydrogen peroxide as an oxidant together with small amounts of a transition metal salt (e.g. ferrous salt) and an acid to reduce the pH to the optimal range. The transition metal acts as a catalyst to liberate hydroxyl radicals from the hydrogen peroxide which are able to attack organic molecules of various types.

“Recovered carbon black” or “rCB” refers to a carbon black material obtained from recycling a material containing carbon black. In preferred examples, the rCB is obtained by pyrolysis of waste tyres from automobiles, trucks, agriculture equipment and the like.

We also provide methods of pelletizing rCB with a binder composition comprising a mixture of a Fenton solution, and optionally a surfactant.

We further provide methods of oxidizing the “fluffy” carbon black in the gas phase with oxygen or ozone prior to pellet formation by treatment with a Fenton solution.

We still further provide rCB pellets comprising a binder composition including a Fenton solution.

We yet further provide aqueous slurries of carbon black, in which the Fenton solution is used as the liquid medium.

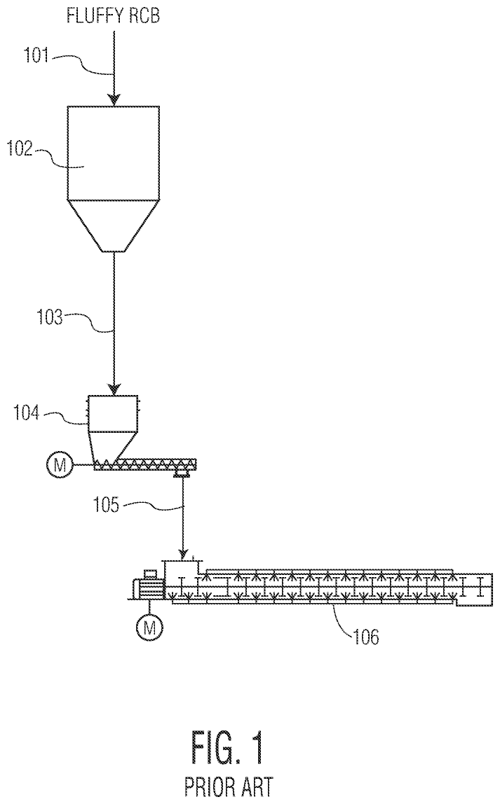

Carbon black is commonly sold commercially as pellets. Referring now to FIG. 1, a conventional wet pellet formation system is depicted. In FIG. 1, low density (“fluffy”) CB is delivered from milling by flow line 101 to hopper 102. The material then flows through flow line 103 to dosing screw feeder 104 which controls the flow of fluffy CB through flow line 105 to the pellet mill 106 on a gravimetric basis. Optionally, oxygen or ozone may be introduced via an additional line (not shown) to oxidize the carbon black before the carbon black enters the pellet mill 106.

The pellet mill 106 typically is of the pin mill or pug mill variety and may have a cylindrical shell with a central, rotating shaft to which a number of pins are affixed. Liquid binder is introduced at a controlled rate sequentially through a number of nozzles. The carbon black enters as a fine powder and receives a number of additions of small amounts of binder as it passes through the device until finally leaving as pellets which are typically from 1 to 2 mm in diameter.

Agglomeration of fines requires that the binder first be dispersed as fine drops which form nuclei to which the fine particles are able to bind. If the binder material is too good as a wetting agent (typically meaning dielectric constant below 10), it wets the solids too rapidly and forms a paste rather than individual granules. This applies to typical non-polar solvents such as benzene. Water is a suitable liquid binder by virtue of its high surface tension (73 dynes per cm²) and high dielectric constant (81). Polar solvents such as acetone (surface tension 23, dielectric 26.6) are possible and are more efficient wetting agents but less efficient as agglomerating agents. This means that agglomerates made, for example, with acetone are lower density and weaker than those made with water. The suitability of water as a wetting agent also depends on the surface properties of the carbon, and it is found that carbons that are too poorly wetted typically require the addition of a surfactant to the binder.

In selected representative examples, the binder composition supplied to the pellet mill during pelletization of rCB may comprise a Fenton solution. Suitable binder compositions may comprise Fenton solution diluted in water at a hydrogen peroxide concentration of at least 0.5%, at least 1%, at least 5%, at least 10%, at least 15%, at least 25%, at least 30%, at least 40%, at least 50%, at least 60% at least 70%, at least 80%.

In the examples, a slurry of recovered carbon black may be produced by dispersing recovered carbon black in a liquid medium, wherein the liquid medium comprises a Fenton solution including a transition metal salt, water, an acid and hydrogen peroxide. The mixing ratios may be selected by those skilled in the art based on the desired properties of the slurry and rate of the Fenton reaction.

Exemplary Fenton reactions are:

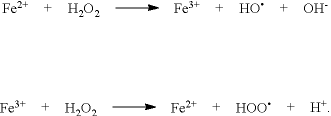

The chemistry of Fenton solution is well known and a typical reaction sequence is: Iron(II) is oxidized by hydrogen peroxide to iron(III), forming a hydroxyl radical (*OH) and a hydroxide ion (OH) in the process. Iron(III) is later reduced back to iron(II) by another molecule of hydrogen peroxide, forming a hydroperoxyl radical (*OOH) and a hydrogen ion (H⁺ or H₃O⁺). The net effect is a disproportionation of hydrogen peroxide to create two different oxygen-radical species, (*OH and *OOH) with water as a by-product. The free radicals are both oxidizing agents and react with the carbon surface as well as residual volatile matter (or precursors such as unconverted rubber), with a substantial modification of the effective surface of the carbon black particles by the addition of oxygen-containing moieties such as but not limited to phenol groups and carboxylic acids. These groups are typically formed by chain reactions predominantly initiated by the hydroxyl radical. An example of such a chain reaction may be as follows:

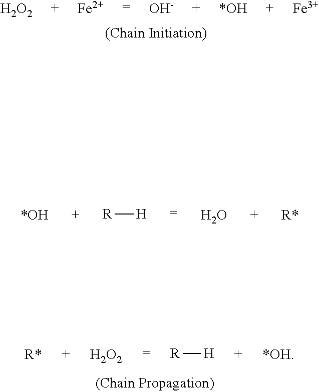

The *OH radical liberated in the second step of chain propagation is available to participate in additional reactions, in particular to abstract hydrogen from elsewhere on the surface to create an additional surface OH group.

Other chain propagation reactions are also possible, in particular, when olefinic unsaturation is present:

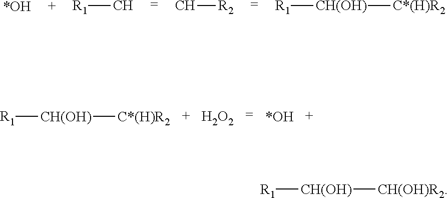

Eventually the chain terminates by reactions such as:

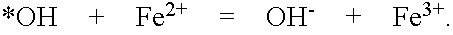

Similar chain reactions are possible with the *OOH radical. However, it is much more stable than *OH and typically reverts to hydrogen peroxide when it abstracts a radical. Since there is some amount of olefinic unsaturation, there will be some hydroperoxide groups attached to the surface. The hydroperoxide radical can also react with hydroxyl ions to form superoxide anion, which is also a highly reactive form of oxygen and able to react with the surface.

When iron is used as the transition metal, it is preferable to maintain the pH in a preferred range. If the pH is too low, Fe²⁺ can be tied up as the complex Fe (H₂O)₆²⁺ and less available to react with H₂O₂. Furthermore, free H₃O+ ions can scavenge hydroxyl radicals. If the pH is too high, ferric iron is precipitated as the hydroxide, the hydrogen peroxide is less stable and can break down in other ways.

The rate of reaction of the Fenton reaction can be adjusted by varying the acid used and its concentration (hence the pH of the solution), the concentration of the transition metal salt (which effectively functions as a catalyst) and the concentration of hydrogen peroxide, or a combination thereof. The total amount of oxidation occurring can be adjusted by varying the concentration of hydrogen peroxide and/or the total binder to solids ratio. In addition to these adjustments to the composition and amount of Fenton solution employed, it is also possible to stage the addition of Fenton solution within the pellet mill, for example, to inject the Fenton solution only towards the front of the mill (closer to where the powdered recovered carbon black enters), rather than evenly throughout the mill. These adjustments make it possible to customize the amount of treatment that the carbon black receives, for example, to be able to adjust the pH of the final recovered carbon black (as measured by ASTM D1512). In this regard, it may be desirable to produce carbon blacks with differing pH levels for different applications (for example, lower for inks, higher for tires).

The extent of the treatment can be adjusted by varying the amount of Fenton solution used or its concentration to customize the surface properties to achieve a desired effect. Generally, the treatment reduces the volatile carbonaceous material (VCM) content of the recovered carbon black and reduces the surface pH (as measured by ASTM D-1512). The desirable changes compared to the untreated rCB material are to reduce the measured VCM value to meet a specification, to improve the interaction between the recovered carbon black and a specific rubber compound to improve performance of the filled rubber, and to enable efficient suspension of the recovered black in aqueous media (for example, in inks).

Suitable examples of the transition metal salt of the Fenton solution include but are not limited to iron(II) sulfate (FeSO₄), iron(II) acetate, iron(II) chloride, iron(II) nitrate, iron(II) hydroxide or a combination thereof.

A Fenton solution may suitably comprise transition metal salt in an amount of at least 0.001%, at least 0.005%, at least 0.01%, at least 0.05%, or at least 0.1%. A Fenton solution may suitably comprise transition metal salt in an amount of less than 5%, less than 3%, less than 1%, less than 0.5%, less than 0.25% or less than 0.1%.

Suitable examples of the acid of the Fenton solution include but are not limited to weak acids such as acetic acid and formic acid, hydrochloric acid, inorganic acids or a combination thereof. Inorganic acids such as phosphoric acid, as less preferred as residual material will remain in the product. Generally, oxalic acid is not preferred due to the low solubility of the iron salt.

A Fenton solution may suitably comprise acid in an amount of at least 0.1%, at least 0.25%, at least 0.5%, at least 75%, at least 1%, at least 1.5%, at least 2%, at least 3%, at least 4%, or at least 5%. A Fenton solution may suitably comprise acid in an amount of less than 25%, less than 20%, less than 15%, less than 10%, or less than 5%.

The concentration of the hydrogen peroxide in the Fenton solution may be determined based on a desired rate of the reaction. Suitable concentrations of hydrogen peroxide in the Fenton solution may be at least 1%, at least 2%, at least 3%, at least 4%, at least 5%, at least 6%, at least 7%, at least 8%, at least 9%, at least 10%, at least 15%, at least 20%, at least 25%, at least 30%, or at least 35%. Suitable concentrations of hydrogen peroxide in the Fenton solution may be less than 50%, less than 45%, less than 40%, less than 35%, less than 30%, less than 25%, or less than 20%.

An exemplary Fenton solution may include 0.01 to 0.1% FeSO₄, 1-5% CH₃COOH, and 3-50% H₂O₂, with the balance being water.

A suitable pH range for the Fenton reaction is about 2 to about 5, more preferably the Fenton reaction is performed in the pH range of about 3 to about 4.

In recovered carbon black prepared by pyrolysis, there is usually a correlation between the amount of residual hydrocarbons (measured by using the amount of VCM as an index) and the chemical nature of the surface (measured by ASTM D-1512 pH). With conventional pyrolysis processes, it is possible to reduce the VCM content, but this typically has the effect of simultaneously reducing surface oxygenated sites and elevating the pH of the rCB. As a result, the surface becomes less compatible with rubber compounds as the VCM content is reduced.

We determined that the use of a Fenton solution treatment such as during pellet formation is able to reduce the VCM and maintain a sufficiently low pH, simultaneously. We discovered that, at the same pH value, the carbon surface treated with Fenton contains a significantly higher fraction of oxygenated species than untreated rCB. Moreover, the in-rubber performance of rCB obtained using Fenton solution is superior to rCB obtained without using the Fenton solution. This can be advantageous in several different contexts:
While it is possible to produce a recovered carbon black that is good enough for semi-reinforcing applications where the conventional material is grade N772 carbon black, the Fenton treatment enables the rCB to be used in somewhat more challenging applications where N660 or even N550 carbons are used.
It is possible to use the Fenton solution as a “correction fluid” to improve batches of recovered carbon black which are outside the specification by virtue of too high volatile content.
It is possible to change the operating point of the pyrolysis unit, deliberately allowing a higher VCM slip. This would be done to improve the yield of liquid hydrocarbons from the pyrolysis unit.

It is also possible to use Fenton solution in conjunction with a secondary pyrolysis process. In that process, secondary pyrolysis is used to reduce the VCM content and Fenton solution is used to correct the pH.

Higher amounts of Fenton solution can be used to deeply oxidize the surface of the carbon to make the carbon easier to disperse in water and other polar solvents. This can be useful in the context of inks and pigments.

The recovered carbon black treated with Fenton solution has an advantageous balance of pH (measured by ASTM D-1512 pH) and low amount of residual hydrocarbons (measured by VCM, which is expressed in units of mass percentage and is derived from Thermogravimetric Analysis, TGA, alternatively may be expressed in terms of the weight fraction of material remaining in the rCB that is extracted using toluene under standard conditions). For rubber reinforcement, preferably the pH of the rCB should be 5 to 9, more preferably 6 to 8. Preferably, the pH of the rCB is about 7. The VCM is preferably below about 3%, more preferably below about 2.75%, and more preferably below about 2.5%.

Recovered carbon black treated with a Fenton solution can be used in place of virgin carbon black in various applications. In the examples, a molded article may comprise a formulated rubber compound reinforced with the recovered carbon black treated with a Fenton solution. Examples of a molded article include tires, pipes, tubes, cables, rubber goods and the like.

While pelletized carbon black is discussed above, it should be understood that our methods also apply to a powdered carbon black composition comprising recovered carbon black treated with a Fenton solution. For example, carbon black pellets prepared as described above may be milled into a powder.

### EXAMPLES

### Comparative Examples 1 to 3: Conventional Pelletization with Water Binder

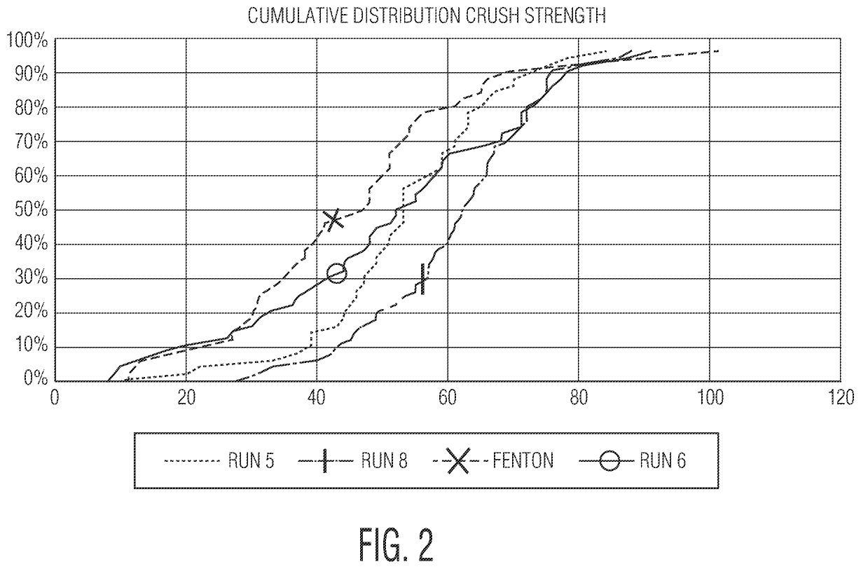

rCB was pelleted using a conventional wet pellet formation system as depicted in FIG. 1. Water was used as a binder. Comparative Example 1 (Run 5) and Comparative Example 2 (Run 8) used 38% binder to solids ratio and Comparative Example 3 (Run 6) used 40% binder to solids ratio. The pellet size distribution is shown in Table 2 below. The compression strength is shown in Table 3. FIG. 2 shows cumulative distribution crush strength.

### Example 1: Pelletization with Fenton Solution

A dilute Fenton solution was prepared as set forth in Table 1:

TABLE 1

| | |
|---|---|
| 3% Hydrogen peroxide (aqueous) | 500 ml per liter solution |
| Ferrous Sulfate | 1.6 grams per liter solution |
| 5% acetic acid | 12 ml per liter solution |
| Water | ~486 ml per liter |

A 1.5% solution of Fenton solution of Table 1 diluted in water was used as a binder to pelletize rCB at a binder to solids ratio of 38%. Apart from the addition of Fenton solution to the water binder, other processing parameters were kept the same as Comparative Examples 1 to 3. The pellet size distribution is shown in Table 2 below. The compression strength is shown in Table 3. FIG. 2 shows cumulative distribution crush strength.

TABLE 2
Pellet Size Distribution

| | Binder | | | | | | | | | |
|---|---|---|---|---|---|---|---|---|---|---|
| | composition | mm: | 2.83 | 2 | 1 | 0.5 | 0.25 | 0.125 | 0.044 | 0 |
| Comparative | 38% H₂O | retained: | 0.10% | 0.10% | 51.00% | 44.90% | 3.40% | 0.30% | 0.00% | 0.00% |
| Example 1 | | cumulative: | 0.10% | 0.20% | 51.20% | 96.20% | 99.60% | 99.90% | 100.00% | 100.00% |
| Comparative | 38% H₂O | retained: | 0.30% | 0.10% | 66.90% | 31.20% | 1.20% | 0.20% | 0.10% | 0.10% |
| Example 2 | | cumulative: | 0.30% | 0.30% | 67.20% | 98.40% | 99.70% | 99.80% | 99.90% | 100.00% |
| Example 1 | 38% Fenton | retained: | 5.30% | 8.70% | 44.90% | 33.60% | 6.10% | 1.20% | 0.30% | 0.10% |
| | | cumulative: | 5.30% | 13.90% | 58.80% | 92.40% | 98.50% | 99.60% | 99.90% | 100.00% |
| Comparative | 40% H₂O | retained: | 1.90% | 18.80% | 59.80% | 14.30% | 3.30% | 1.10% | 0.50% | 0.20% |
| Example 3 | | cumulative: | 1.90% | 20.70% | 80.50% | 94.90% | 98.20% | 99.30% | 99.80% | 100.00% |

As shown in Table 2, the pellets of Example 1 were shown to be distinguishable from pellets made from same raw material without use of Fenton solution. The pellets prepared in Example 1 using Fenton solution were somewhat weaker and slightly larger than those prepared without Fenton solution.

TABLE 3

| | | Compression Strength (g) | | | | |
|---|---|---|---|---|---|---|
| | Test Run | μ | max | min | Med | σ |
| Comparative | Run 5 - 38% H₂O | 53 | 85 | 10 | 53 | 15 |
| Example 1 | | | | | | |
| Comparative | Run 8 - 38% H₂O | 61 | 92 | 28 | 62 | 14 |
| Example 2 | | | | | | |
| Example 1 | Fenton Run - 38% | 46 | 107 | 11 | 46 | 21 |
| Comparative | Run 6 - 40% H₂O | 52 | 100 | 8 | 52 | 22 |
| Example 3 | | | | | | |

As shown in Table 3, there are some differences in size and strength between two runs at nominally the same conditions (Comparative Examples 1 and 2) using traditional methods and water as a binder.

The pellet size and strength may be slightly altered by the use of Fenton solution. The particles are about the same size as when water was used at the same dosing rate, but a little weaker. However, the particles are of similar strength to those produced when a little more water was used as in Comparative Example 3. The conclusion is that using Fenton solution may slightly weaken the pellets. However, it should be with a range that can be cured by changing the binder to pellet ratio slightly.

### Example 2: In-Rubber Performance of Fenton Modifier rCB Compared to Base rCB

The pellets prepared in Comparative Example 1 (Run 5) and Comparative Example 2 (Run 8) and Example 1 were tested for colligative properties as well as in-rubber performance. The colligative properties are shown in Table 4.

TABLE 4

| | | | Comparative | Comparative | |
|---|---|---|---|---|---|
| | | | Example 1 | Example 2 | Example 1 |
| | Unit | ASTM | Run 5 | Run 8 | Fenton |
| NSA | m²/g | D6556 | 72.3 | 70.7 | 69.8 |
| STSA | | D6556 | 72.1 | 69.8 | 67.7 |
| Moisture Content | Wt % | D1509 | 0.6 | 1.2 | 0.16 |
| TGA | Volatiles | | 2.4 | 2.4 | 2.3 |
| TGA | Carbon | | 78.4 | 78.3 | 77.8 |
| TGA | Ash | | 19.1 | 19.3 | 19.9 |
| Ash EDX | Silicon | | 28.9 | 28.5 | 28.8 |
| Ash EDX | Zinc | | 25.5 | 28.1 | 26.8 |
| Ash EDX | Oxygen | | 27 | 25.1 | 25.9 |
| Ash | Wt % | D1506 | 20 | 20 | 20 |
| Sulphur Content | % | D1619 | 2.98 | 2.88 | 2.84 |
| Toluene | % | D1618 | 61 | 66 | 69 |
| Discoloration | | | | | |
| pH | | D1512 | 8.4 | 8.2 | 7.3 |
| Pour Density | g/l | D1513 | 523 | 537 | 520 |
| TOTAL of 8 EU | ppm | | 10.1 | 9.8 | 8.1 |
| PAHs | | | | | |
| TOTAL of 22 | ppm | | 76 | 74 | 65 |
| FDA PAHs | | | | | |

The differences are small but very significant. In particular, there is a significant change in the pH (7.3 versus 8.3, a factor of 10). There is also a discernable difference in the toluene transmittance (69 compared to an average of 63.5). The PAHs are also lower. The surface area is also slightly lower.

All of the observed changes are consistent with our understanding of how the Fenton solution works to oxidize the material.

In-rubber performance of Example 1 and Comparative Examples 1 and 2 in styrene-butadiene rubber (SBR) is shown in Table 5 as compared to commercial grade carbon black N770, N660, N550 and N330.

TABLE 5

| rCB Samples | | | Reference CB Materials | | | |
|---|---|---|---|---|---|---|
| Comp. Ex. 1 | Comp. Ex. 2 | Ex. 1 | N770 | N660 | N550 | N330 |

Cure Properties

| | | | | | | | | |
|---|---|---|---|---|---|---|---|---|
| Min | dNm | 1.72 | 1.82 | 1.82 | 1.29 | 1.54 | 1.82 | 2.42 |
| Max | dNm | 15.26 | 14.96 | 16.14 | 14.67 | 16.67 | 17.35 | 19.55 |
| Ts2 | min | 5.69 | 5.79 | 4.9 | 5.54 | 5.03 | 5.1 | 4.06 |
| T90 | min | 14.16 | 12.46 | 12.9 | 11.06 | 11.72 | 10.85 | 9.13 |

Physical Properties

| | | | | | | | | |
|---|---|---|---|---|---|---|---|---|
| Shore A | ° | 59 | 59 | 59 | 56 | 59 | 63 | 67 |
| M100% | MPa | 1.96 | 2.05 | 2.21 | 1.69 | 2.45 | 2.83 | 1.61 |
| M300% | MPa | 7.16 | 7.55 | 8.32 | 7.51 | 10.55 | 13.3 | 17 |
| Ten. St. | MPa | 17.9 | 18.4 | 18.9 | 20.3 | 17.1 | 20.2 | 25.9 |
| E@B | % | 629 | 640 | 608 | 580 | 481 | 491 | 453 |
| ΔE′ | | 1.8 | 1.8 | 2.2 | 1.6 | 2.2 | 3.2 | 11.5 |

The in-rubber performance of Example 1 with Fenton solution is better than Comparative Examples 1 and 2 without Fenton solution. In particular the networking efficiency (ΔE′, which is a measure of how well the carbon interacts with the rubber) is significantly better in Example 1.

The networking efficiency (ΔE′) is significantly better for the Fenton treated rCB of Example 1 than for Comparative Examples 1 and 2. In fact, the networking efficiency roughly equals that of N660, while the value for the other two samples is close to that of N770.

Although only limited examples have been described in detail above, those skilled in the art will readily appreciate that many modifications can be possible in the examples without materially departing from the subject matter of this disclosure. Accordingly, all such modifications are intended to be included within the scope of this disclosure as defined in the appended claims. In the claims, means-plus-function clauses are intended to cover the structures described herein as performing the recited function and not only structural equivalents, but also equivalent structures. Thus, although a nail and a screw cannot be structural equivalents in that a nail employs a cylindrical surface to secure wooden parts together, whereas a screw employs a helical surface, in the environment of fastening wooden parts, a nail and a screw can be equivalent structures. It is our express intent that only claims that include the express language “means for” or “step for” be interpreted under 35 U.S.C. 112(f). Claims that do not expressly include the phrase “means for” or “step for” are not to be interpreted under 35 U.S.C. 112(f).

Certain configurations and features have been described using a set of numerical upper limits and a set of numerical lower limits. It should be appreciated that ranges including the combination of any two values (e.g., the combination of any lower value with any upper value, the combination of any two lower values, and/or the combination of any two upper values) are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited herein are fully incorporated by reference to the extent such disclosure is not inconsistent with this disclosure and for all jurisdictions in which such incorporation is permitted.

What is claimed is:

1. A method of producing carbon black pellets comprising:
feeding an amount of unpelletized recovered carbon black as a feed amount into a pellet mill,
dispersing a binder composition into said pellet mill, and
pelletizing the recovered carbon black, wherein the binder composition comprises a Fenton solution.

2. The method of claim 1, wherein the Fenton solution comprises a transition metal salt selected from the group consisting of iron(II) sulfate, iron(II) acetate, iron(II) chloride, iron(II) nitrate, iron(II) hydroxide and combinations thereof.

3. The method of claim 1, wherein the Fenton solution comprises a transition metal in an amount of at least 0.001%.

4. The method of claim 1, wherein the Fenton solution comprises hydrogen peroxide in an amount of at least 1%.

5. The method of claim 1, wherein the binder composition comprises the Fenton solution at a concentration of at least 0.5%.

6. The method of claim 1, wherein the unpelletized carbon black is oxidized in a gas phase with oxygen or ozone prior to pellet formation.

7. A carbon black pellet comprising recovered carbon black and a binder composition, wherein the binder composition comprises a Fenton solution.

8. The carbon black pellet of claim 7, wherein the Fenton solution comprises a transition metal salt selected from the group consisting of iron(II) sulfate, iron(II) acetate, iron(II) chloride, iron(II) nitrate, iron(II) hydroxide and combinations thereof.

9. The carbon black pellet of claim 7, wherein the Fenton solution comprises a transition metal in an amount of at least 0.001%.

10. The carbon black pellet of claim 7, wherein the Fenton solution comprises hydrogen peroxide in an amount of at least 1%.

11. The carbon black pellet of claim 7, wherein the binder composition comprises the Fenton solution at a concentration of at least 0.5%.

12. The carbon black pellet of claim 7, wherein a pH of the carbon black pellet is about 5 to about 9.

13. The carbon black pellet of claim 7, wherein a pH of the carbon black pellet is about 6 to about 8.

14. The carbon black pellet of claim 7, wherein a VCM is below 3% mass.

15. The carbon black pellet of claim 7, wherein a VCM is below 2.5% mass.

16. A carbon black slurry comprising recovered carbon black dispersed in a liquid medium, wherein the liquid medium comprises a Fenton solution.

17. The method of claim 1, wherein a pH of the slurry is about 5 to about 9.

18. A molded article comprising the carbon black pellets of claim 7.

19. A powdered carbon black composition comprising recovered carbon black treated with a Fenton solution.
